(19) United States
(12) Patent Application Publication
(10) Pub. No.: US 2005/0033972 A1
(43) Pub. Date: Feb. 10, 2005

(54) Dual virtual machine and trusted platform module architecture for next generation media players

(76) Inventor: Scott F. Watson, Santa Clarita, CA (US)

Correspondence Address: DONALD L. WENSKAY, ESQ.;C/O GREENBERG TRAURIG LLP, INTELLECTUAL PROPERTY DEPARTMENT, 2450 COLORADO AVENUE, SUITE 400E, SANTA MONICA, CA, 90404, US

(21) Appl. No.: 10/880,060

(22) Filed: Jun. 28, 2004

Related U.S. Application Data
(60) Provisional application No. 60/481,034, filed on Jun. 27, 2003.
(60) Provisional application No. 60/481,066, filed on Jul. 7, 2003.
(60) Provisional application No. 60/493,072, filed on Aug. 5, 2003.

(51) Int. Cl. H04L 9/32

(52) U.S. Cl. 713/189

(57) ABSTRACT

A software computing based environment for providing secured authentication of media downloaded from a network or loaded from a media player includes two peer-mode operating virtual machines. The low-level virtual machine provides decoding and decryption functions whereas the high-level virtual machine provides application level functions such as user interface, input/output.

### RELATED APPLICATIONS

This application claims priority to U.S. Provisional Application No. 60/481,034 entitled “Dual Virtual Machine Architecture” which was filed on Jun. 27, 2003, and is also related to U.S. Provisional Application No. 60/481,066 entitled “Dual Virtual Machine Architecture for Copy Protection” filed on Jul. 7, 2003, and No. 60/493,072 entitled “Dual Virtual Machine and Trusted Platform Module Architecture for Next Generation Media Players” filed on Aug. 5, 2003, the contents of which are incorporated by reference herein in their entirety.

### BACKGROUND

1. Field

The disclosure relates to developing new systems and methods of security, including copy protection for removable media players.

2. General Background and State of the Art

A virtual machine (VM) is a term used to describe software that acts as an interface between compiler code and the microprocessor (or “hardware platform”) that actually performs the program's instructions. A compiler is a special program that processes statements written in a particular programming language and turns them into binary machine language or “code” that a computer's processor uses.

Sun Microsystems, developers of the Java programming language and runtime environment, is well known for their development of the Java Virtual Machine. A Java virtual machine interprets compiled Java binary code (called byte code) for a computer's processor (or “hardware platform”) so that it can perform a Java program's instructions.

Java was designed to allow application programs to be built that could be run on any platform without having to be rewritten or recompiled by the programmer for each separate platform. Once a Java virtual machine has been provided for a platform, any Java program can run on that platform. A Java virtual machine makes this possible because it is aware of the specific instruction lengths and other particularities of the platform.

A virtual machine is an abstract computing machine. Like a real computing machine, it has an instruction set and manipulates various memory areas at run time. It is reasonably common to implement a programming language using a virtual machine; the best-known virtual machine may be the P-Code machine of UCSD Pascal.

A virtual machine can otherwise more generally describe either an operating system or any program that runs a computer.

There has been a long felt need to develop improved methods of copy protection in next generation media players, such as a DVD or CD player.

One known content security system used for DVD's is the Content Scramble System (CSS) whereby the data on a DVD is encrypted. The DVD player then decrypts the data as it reads the disc using a 40 bit decryption key. A fatal flaw of CSS, however, proved to be that its keys and algorithms were static. The encryption algorithm was reverse engineered, and every possible decryption key that would play existing DVD discs was made available. Once the secret escaped, the system was forever compromised since there was no way to renew the security algorithms or keys. There are now many programs available to consumers which remove all security from DVD content with a single “click”.

Content owners do not want this to happen again, especially as the fidelity of the content increases. The next content security system should therefore not be vulnerable in this way.

Software vendors have also faced their share of piracy, but given the nature of computers, they have taken a different approach than that used in the entertainment industry for DVDs. Historically, packaged software program (i.e. computer games) manufacturers have protected their content with “procedural security”. That is, there is no static pre-defined method for securing programs, instead each software producer writes or procures a “security code” to secure their content. This procedural security code varies in complexity and technique on a program by program basis, but most importantly, since each program has a different security software implementation, it is not possible to write a general purpose ‘remove security’ program, like those written to circumvent DVD security.

Another known method of copy protection is writing hardware specific instructions. The problem with such a method is that this is extremely limiting. With this method, a different set of instructions must be rendered for each hardware configuration. This is somewhat impractical.

Therefore, a method of providing copy protection to hardware such as media players, that is not hardware specific, is desired.

### SUMMARY

A system and method of platform independent procedural copy protection is therefore provided to media players. The present disclosure proposes a solution whereby a dual virtual machine architecture is provided to next generation media players. The present disclosure further proposes utilizing a hardware-based embedded security subsystem such as a trusted platform module (TPM) to interface with certain aspects of the virtual machine architecture.

The dual virtual machine architecture in accordance with the present disclosure consists of a high level virtual machine and a low level virtual machine. The low-level virtual machine is designed to support low-level media decryption and decoding functions, whereas the high level virtual machine is designed to handle application layer activities. The architecture therefore partitions security software from application software.

In general, a virtual machine that is best suited for procedural security more closely resembles the instruction set of an actual hardware CPU. That is, it supports pointers, and no underlying distinction is made between executable code and data. This first type of virtual machine is therefore named a “low-level VM”, or “Security-VM.” The low-level virtual machine is designed to resemble a conventional CPU supporting tamper resistant software techniques.

The downside to a virtual machine like this is that programming errors or unexpected runtime conditions tend to be fatal. For a security system, this can be considered a strength, but for applications (which are much more complicated, and typically have less intensive test coverage) this is a liability.

For applications, a “high-level VM” that manages more of the computational details “behind-the-scenes” allows more dependable application programs to be developed that behave in a more predictable and robust fashion. A typical example of a “high-level virtual machine is Java. For instance, Java does not have support for the concepts of “pointer” or explicit memory management (which are common sources of programming errors), but does support “exception handling” which helps programs and programmers handle unexpected runtime conditions in a predictable way.

The high-level, or application level virtual machine is designed to be full featured, and provide for a rich application interface.

Therefore, it is ideal to combine the benefits of both a low-level VM and a high-level VM in order to provide platform independent security functions that work in combination with other applications. Furthermore, a trusted platform module provides hardware based root of trust by securely querying and validating the execution environment.

In an exemplary embodiment, the present disclosure is used for the purposes of renewable security and copy protection in DVD and CD players. However, such an architecture also supports the playback of media stored on a hard drive, solid state memory or that which is delivered over a network.

As mentioned above, the low-level virtual machine is designed to support low-level media decryption and decoding functions. In next generation media (NGM) applications, this low-level virtual machine would also be responsible for bootstrapping the high-level VM. The high-level VM handles application layer activities, like advanced user interfaces, misc. IO, and network activities.

The dual VM architecture of the present disclosure is novel. The dual VM architecture provides a “peer” relationship unlike the conventional “stacked VM” relationship. One example of a stacked relationship of one VM running on top of another, would be a PowerPC (like in a Mac), running a windows emulator (x86 emulator or VM), which in turn executes Java VM.

Furthermore, the combination of such a dual VM architecture with a hardware based trusted computing module is novel.

The present disclosure extends the use of procedural security to media such as CD's and DVD's. In addition, procedural security also allows the content owner much more flexible rights management than declarative systems. This flexibility can be used to implement full fledged Digital Rights Management (DRM) systems, as opposed to simple Copy Protection (CP) provided by prior art static security systems like CSS.

The foregoing and other objects, features, and advantages of the present disclosure will be become apparent from a reading of the following detailed description of exemplary embodiments thereof, which illustrate the features and advantages of the disclosure.

### BRIEF DESCRIPTION OF THE DRAWINGS

FIG. 1 is a diagram of a media player architecture in a computing environment according to an exemplary embodiment.

FIG. 2 is a block diagram depicting the interaction and functionalities of the low-level virtual manager and the high-level virtual manager according to an exemplary embodiment.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION

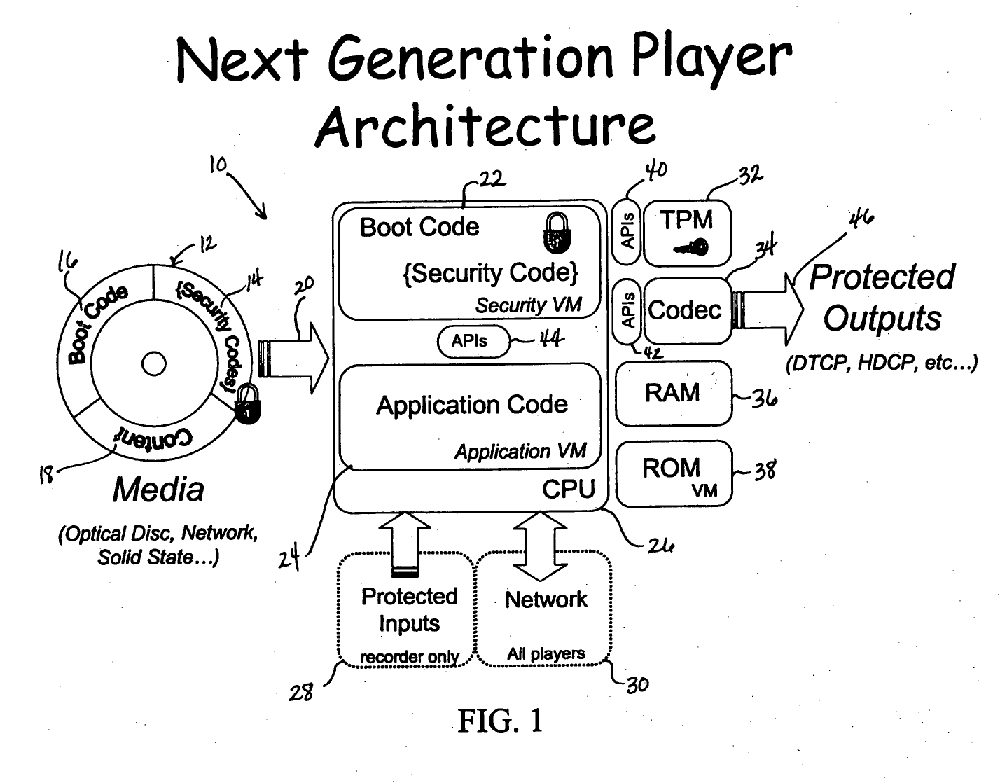

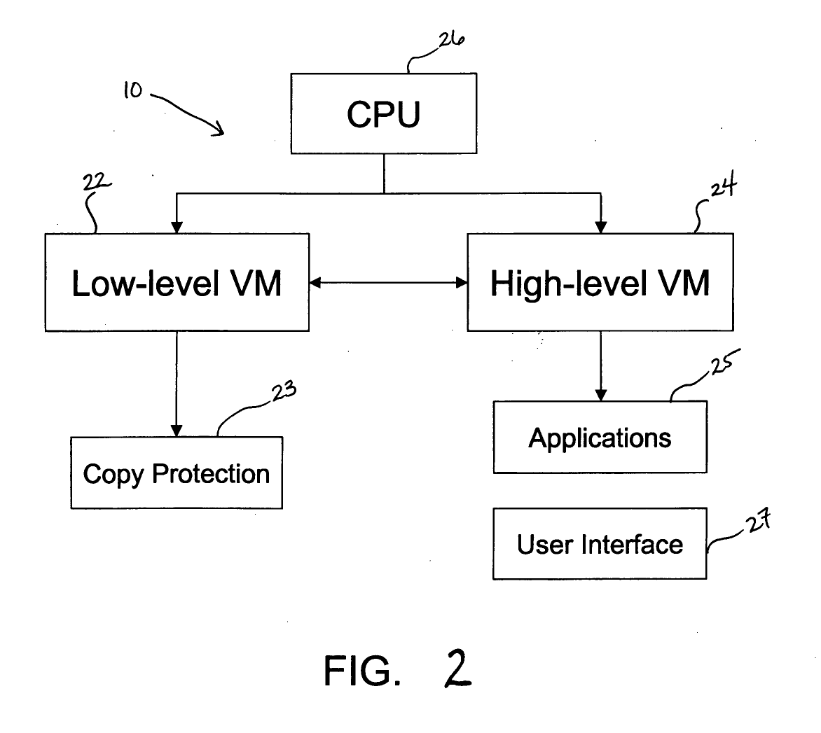

Detailed descriptions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present disclosure in virtually any appropriately detailed structure. Reference will now be made in detail to that disclosure which is illustrated in the accompanying drawing (FIGS. 1-2).

The system and method of the present disclosure provides a dual virtual machine architecture for use media players. One VM is designed to support security functions such as media decryption and decoding. In next-generation media applications, the low-level VM may be responsible for bootstrapping the application level VM. The high-level or application level VM handles application layer activities, like advanced user interfaces, misc. IO, and network activities.

FIGS. 1 and 2 depict of a media player architecture in a computing environment 10 according to an exemplary embodiment. Specifically, shown therein is a media source (e.g., a DVD, an optical disk, a solid-state device, or a network) that includes media data or content 18, security codes 12 for permitting the media to be played back on the media player, and boot codes 16.

The media playback device in accordance with the present disclosure contains a central processing unit 26 capable of running at leas one Virtual Machine (VM). The Virtual Machine, in an exemplary embodiment, is a dual virtual machine architecture, comprising a low-level VM (e.g., a security VM) 22 and a high-level VM (e.g., an application VM) 24 running on the CPU 26. Programs that are run in the VM may execute and enforce usage rules as well as update cryptographic algorithms. The computing environment 10 may also include Application Program Interfaces (API's) 40-44 which are a set of routines or protocols for permitting various programs to communicate with each other.

In one aspect any one of the VM (22 or 24) may control the other VM. In another aspect, the high-level and low-level virtual machines function as peers, in a non-hierarchical manner, passing messages between themselves. These messages may be implemented as “foreign-function calls”, where one virtual machine calls a routine in the other virtual machine, or as conventional messages passed along a communications channel.

For instance, the application VM (or high-level VM) 24 would call the security-VM (or low-level VM) 22 in order to start playback (and hence transparent decoding) of media content 18.

Likewise, code in the security VM 22 would call the application VM 24 to let it know about synchronization events or decoding problems (for example security or permission problems).

For example, in the situation where media has been copied off of it's original optical media, the security VM 22 would inform the application VM 24 that it needs a key in order to continue playing. In response, the application VM 24 would display a message, via the application level functions 25, notifying the user that they may “rent” this movie for a certain duration through the user interface 27. If the user chooses to do this, the user must engage in a transaction with a studio server to obtain an ‘opaque message’ (only understandable by the VM) that contains the key. The application VM 24 then passes the message containing the key back to the security VM 22 and the copy protection algorithms 23 for authentication.

The media playback device further contains a processing module (e.g., a Trusted Processing Module or TPM) 32. The TPM specification is part of the Trusted Computing Platform Alliance (TCPA) specification created by the Trusted Computing Group (TCG) (htttp://www.trustedcomputinggroup.org). The TPM 32 contains decryption keys and handles secure cryptographic computations. The media playback device further contains API's 40, 42 allowing any program running in the Virtual Machine to query the device's I/O hardware and TPM. This allows a program executing in the VM to make intelligent choices for usage rules. A decoding module 34, attached to the CPU 26, is further provided for unpacking encoded audio/video streams.

In general, a trusted platform enables an entity to determine the state of the software or computing environment 10 in that platform and to seal data to a particular software environment in that platform. The entity deduces whether the state of the computing environment is acceptable and performs some transaction with that platform. If the transaction involves sensitive data that must be stored on the platform, the entity can ensure that that data is held in a confidential format unless the state of the computing environment in that platform is acceptable to the entity.

To enable this, a Trusted Platform provides information to enable the entity to deduce the software environment in a Trusted Platform. That information is reliably measured and reported to the entity. At the same time, a Trusted Platform provides a means to encrypt cryptographic keys and to state the software environment that must be in place before the keys can be decrypted.

A “trusted measurement root” measures certain platform characteristics, logs the measurement data in a measurement store, and stores the final result in a TPM (which contains the root of trust for storing and reporting integrity metrics). The TPM is therefore a secure storage location for all decryption keys. The TPM also handles most cryptographic computations and functions.

The media playback device furthermore has secure, protected inputs and outputs 28, the ability to network with other players 30, memory devices (e.g., RAM 36 and ROM 38).

Thus, according to the exemplary embodiment, separate virtual machines (VM) run in the same computing environment that includes a CPU. The present architecture partitions two virtual managers (viz., the high-level or application VM and the low-level or security VM), wherein the application and security virtual managers communicate through standardized APIs. The functionalities of the application virtual manager includes providing network services to the security code being executed in the security virtual manager, whereas media access and decoding functions are mediated by the security VM such that content security is transparent to application authors.

With regards to the computational complexity, the security VM has low impact on system resources, is a simple, light-weight, low-level, and secure, and appropriate software for this VM may be provided by security vendors. The application VM has relatively larger CPU and memory impact and is responsible for user Interface and input/output functions.

The present disclosure is not limited to use in media players such as conventional CD and DVD players, but could be expanded to run on a PC, or more generalized hardware system which includes functionality to play removable media.

The foregoing description of the preferred embodiments of the disclosure has been presented for the purposes of illustration and description. Other objects, features, and advantages of the present disclosure will be become apparent from a reading of the following Appendix. It is not intended to be exhaustive or to limit the disclosure to the precise form disclosed. Many modifications and variations are possible in light of the above teaching.

1. A dual virtual machine architecture residing in a computing environment, the architecture comprising:
a low-level virtual machine for performing at least one of decoding a media or providing security functions; and
a high-level virtual machine for performing application level functions;
wherein the low-level virtual machine has a peer relationship with the high-level virtual machine.

2. The dual virtual machine architecture of claim 1 wherein the high-level virtual machine includes an application program for interfacing with an user.

3. The dual virtual machine architecture of claim 1 wherein the application level functions include at least one of providing an interface to a user or communicating with a network having the media.

4. The dual virtual machine architecture of claim 1 wherein a security code from the media is delivered by the high-level virtual manager to the low-level virtual manager for decryption.

5. The dual virtual machine architecture of claim 4 wherein the media is available from at least one of a DVD, an optical disk, a network, or a solid state device.

6. The dual virtual machine architecture of claim 1 further including a processing module that includes at least one decryption key.

7. The dual virtual machine architecture of claim 6 wherein the processing module performs secure cryptographic computations.

8. The dual virtual machine architecture of claim 6 wherein the processing module is used for monitoring the computing environment.

9. The dual virtual machine architecture of claim 1 wherein the computing environment includes a central processing unit (CPU).

10. A method of providing procedural copy protection for media players independent of a computing environment, the method comprising the steps of:
providing a low-level virtual machine to perform security functions;
providing a high-level virtual machine to perform user interface and application level functions;
wherein the low-level virtual machine has a peer relationship with the high-level virtual machine.

11. A method of providing procedural copy protection for media players independent of a computing environment of claim 10 further including an application program with the high-level virtual machine for interfacing with an user.

12. A method of providing procedural copy protection for media players independent of a computing environment of claim 10 wherein the application level functions include at least one of providing an interface to a user or communicating with a network having the media.

13. A method of providing procedural copy protection for media players independent of a computing environment of claim 10 further including delivering a security code, available from the media, by the high-level virtual manager to the low-level virtual manager for decryption.

14. A method of providing procedural copy protection for media players independent of a computing environment of claim 13 wherein the media is available from at least one of a DVD, an optical disk, a network, or a solid state device.

15. A method of providing procedural copy protection for media players independent of a computing environment of claim 10 further including a processing module that provides at least one decryption key.

16. A method of providing procedural copy protection for media players independent of a computing environment of claim 15 wherein the processing module performs secure cryptographic computations.

17. A method of providing procedural copy protection for media players independent of a computing environment of claim 15 further including monitoring the computing environment by the processing module.

18. A method of providing procedural copy protection for media players independent of a computing environment of claim 10 wherein the computing environment includes a central processing unit (CPU).
